(19) United States
(12) Patent Application Publication
(10) Pub. No.: US 2010/0328267 A1
(43) Pub. Date: Dec. 30, 2010

(54) OPTICAL TOUCH DEVICE

(75) Inventor: GA-LANE CHEN, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/702,447

(22) Filed: Feb. 9, 2010

(30) Foreign Application Priority Data
Jun. 30, 2009 (CN) 200910303858.4

(51) Int. Cl. G06F 3/041

(52) U.S. Cl. 345/175

(57) ABSTRACT

An exemplary optical touch device includes a display panel including a display surface at a front side thereof, two infrared light sources positioned on the display panel, three linear sensors positioned at three sides of the display panel respectively, a remote control, two infrared camera modules, and a receiver. The infrared light sources are configured for emitting infrared light covering the entire display surface. Each linear sensor is configured for capturing images of the infrared light reflected by any object on the display surface. The remote control is configured for projecting an infrared light spot on the display surface and generating and sending control signals according to a movement of the remote control. The two infrared camera modules are configured for capturing images of a movement track of the infrared light spot on the display surface. The receiver is configured for receiving the control signals.

### BACKGROUND

1. Technical Field

The present disclosure relates to optical touch devices.

2. Description of Related Art

An optical touch device includes a display panel, an infrared light source and linear sensors. The infrared light source emits infrared light to a display surface of the display panel. The linear sensors are positioned around the display surface and are configured for receiving infrared light reflected by any object on the display surface. The reflected infrared light can be processed to determine a position of the object on the display surface. The determined position of the object on the display surface can be used for many applications, such as for inputting information and for controlling a cursor displayed on the display surface. However, it is inconvenient if a user is far away from the display panel when in use.

Therefore, an optical touch device, which can overcome the above problems, is needed.

### BRIEF DESCRIPTION OF THE DRAWINGS

FIG. 1 is an isometric and schematic view of an optical touch device including an optical input device, according to an exemplary embodiment.

FIG. 2 is a functional block diagram of the optical input device of the optical touch device of FIG. 1.

### DETAILED DESCRIPTION

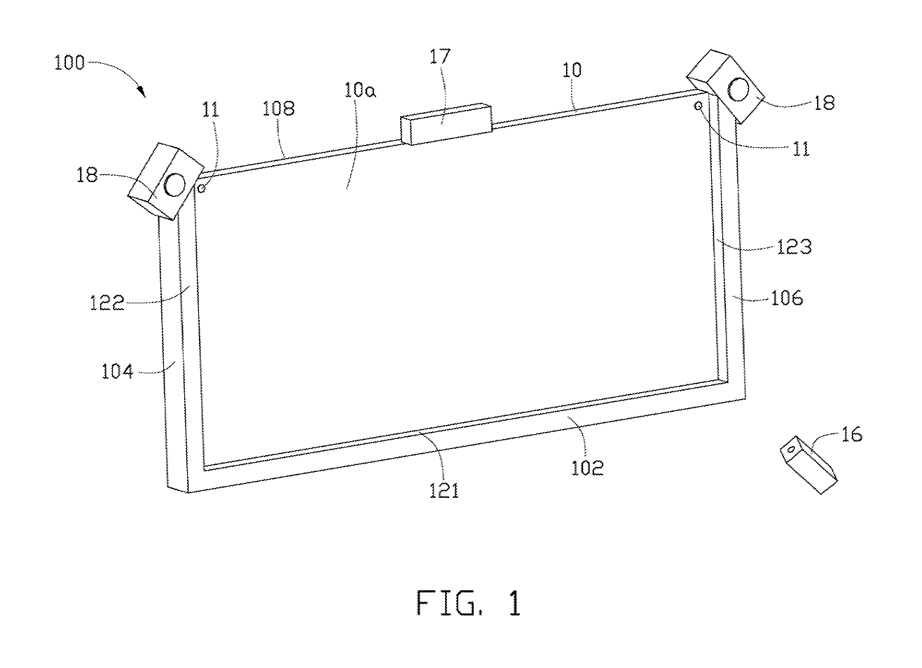

Referring to FIG. 1, an optical touch device 100, according to an exemplary embodiment, includes a display panel 10, two infrared light sources 11, three linear sensors 121, 122, 123, a remote control 16, a receiver 17, and two infrared camera modules 18.

The display panel 10 is substantially rectangular and may be a liquid crystal display or an organic light emitting diode display. The display panel 10 includes a display surface 10a at a front side thereof.

The two infrared light sources 11 are positioned at opposite top corners of the display panel 10. The infrared light source 11 is configured for emitting infrared light covering the entire display surface 10a. The two infrared light sources 11 are infrared light emitting diodes.

The linear sensors 121 122, and 123 are positioned at three sides 102, 104, 106 of the display panel 10. Each linear sensor extends along a lengthwise direction of the corresponding side of the display panel 10. Specifically, the linear sensor 121 is positioned at the bottom side 102 and extends along the lengthwise direction of the bottom side 102. The linear sensor 122 is positioned at the left side 104 and extends along the lengthwise direction of the left side 104. The linear sensor 123 is positioned at the right side 106 and extends along the lengthwise direction of the right side 106. The linear sensors 121, 122, and 123 may be charge coupled devices or complementary metal-oxide semiconductors. The bottom side 102 connects the left side 104 in parallel to the right side 106.

The linear sensor is configured for capturing images of the infrared light reflected by any object, such as a user's finger, touching on the display surface 10a. When the object touches on the display surface 10a, the object reflects the infrared light emitted from the infrared light sources 11. Thus, the linear sensors 121 122, 123 receives the reflected infrared light, and the infrared images are captured accordingly. The infrared images captured by the linear sensors 122, 123 may be used for determining a first position of the object along the right or left side 104/106. The infrared images captured by the linear sensor 121 may be used for determining a second position of the object along the bottom side 102. Therefore, the infrared images captured by the linear sensors 121, 122, 123 can be outputted to an information processing apparatus to determine a two-dimension position and/or movement track of the object touching on the display surface 10a. The determined position and/or movement track of the object can be used for many applications, such as for inputting information and/or for controlling games or a cursor displayed on the display surface 10a. It is to be understood that in alternative embodiments, the optical touch device 100 may include two linear sensors positioned at two adjacent sides of the display panel 10. For example, a linear sensor is positioned at the bottom side 102, and other linear sensor is positioned at the left side 104 or the right side 106.

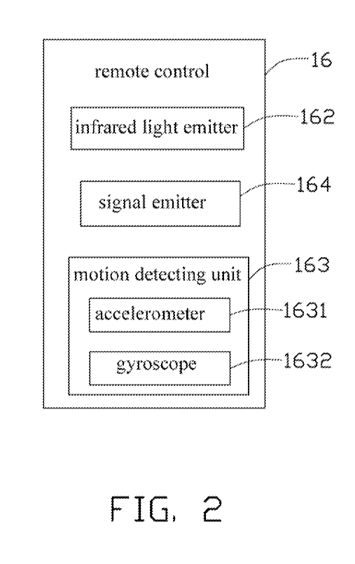

The remote control 16 may be held by a user when in use. The remote control 16 is configured for projecting an infrared light spot on the display surface 10a and generating and sending control signals according to a movement of the remote control 16. In detail, referring to FIG. 2, the remote control 16 includes an infrared light emitter 162, a motion detecting unit 163 and a signal emitter 164.

The infrared light emitter 162 is configured for emitting infrared light to form the infrared light spot on the display surface 10a. The remote control 16 may further include a switch (not shown) for on and off control of the infrared light emitter 162. In this embodiment, the wavelength of the infrared light emitted from the infrared light emitter 162 is different from that of the infrared light emitted from the infrared light source 11. It is to be understood that in an alternative embodiment, the wavelength of the infrared light emitted from the infrared light emitter 162 is substantially same as that of the infrared light emitted from the infrared light source 11. In this alternative embodiment, when in use, the infrared light sources 11 and the infrared light emitter 162 can not be turned on at a same time.

The motion detecting unit 163 is configured for detecting the movement of the remote control 16 to generate the control signals. The motion detecting unit 163 includes an accelerometer 1631 and a gyroscope 1632. The accelerometer 1631 may be a triaxial accelerometer and is configured for detecting accelerations of the remote control 16. The gyroscope 1632 may be a triaxial gyroscope and is configured for detecting angular velocities of the remote control 16. The user holds the remote control 16, so the user can input commands by moving the remote control 16 even if the user is far away from the display panel 10.

The signal emitter 164 is configured for sending the control signals generated by the motion detecting unit 163 to the receiver 17. The control signals are formed according to the accelerations and/or the angular velocities of the remote control 16.

The receiver 17 is electrically connected to the display panel 10 and is configured for receiving the control signals sent by the signal emitter 164. The receiver 17 is positioned on a top side 108 of the display panel 10. In alternative embodiments, the receiver 17 may be positioned near the display panel 10. The received control signals may be transmitted to an information processing unit and be processed for many applications, such as for inputting information and/or controlling games.

The two infrared camera modules 18 are positioned at the top corners of the display panel 10. The infrared camera module 18 is configured for capturing images of a movement track of the infrared light spot projected by the remote control 16 on the display surface 10a. The captured images of the movement track of the infrared light spot can be processed and used for many applications, such as for inputting information and/or controlling games. A field of view of the infrared camera module 18 covers the entire display surface 10a of the display panel 10.

When in use, the remote control 16 is held by the user. The infrared light emitter 162 is turned on if necessary. The infrared light emitter 162 projects the infrared light spot onto the display surface 10a of the display panel 10. The infrared camera modules 18 capture the images of the movement track of the infrared light spot. The motion of the user and the remote control 16 can be detected by the motion detecting unit 163 and control signals are generated accordingly. The control signals are then sent out by the signal emitter 164 to the receiver 17 and may be processed by the information processing unit in the optical touch device and used for many applications, such as for controlling games and/or a cursor displayed in the display panel 10.

Commands can be input by users using the remote control 16, so it is convenient even if the user is far away from the display panel 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical touch device, comprising:
a display panel comprising a display surface at a front side thereof;
at least one infrared light source positioned on the display panel and configured for emitting infrared light covering the entire display surface;
at least two linear sensors positioned at two adjacent sides of the display panel respectively, each linear sensor configured for capturing images of the infrared light reflected by any object on the display surface;
a remote control configured for projecting an infrared light spot on the display surface and generating and sending control signals according to a movement of the remote control;
at least one infrared camera module configured for capturing images of a movement track of the infrared light spot on the display surface; and
a receiver configured for receiving the control signals.

2. The optical touch device of claim 1, wherein the remote control comprises an infrared light emitter, a motion detecting unit and a signal emitter, the infrared light emitter configured for emitting infrared light to form the infrared light spot on the display surface, the motion detecting unit configured for detecting the movement of the remote control to generate the control signals, the signal emitter configured for sending the control signals to the receiver.

3. The optical touch device of claim 2, wherein the motion detecting unit comprises an accelerometer and a gyroscope.

4. The optical touch device of claim 2, wherein a wavelength of the infrared light emitted from the infrared light emitter is different from that of the infrared light emitted from the at least one infrared light source.

5. The optical touch device of claim 2, wherein a wavelength of the infrared light emitted from the infrared light emitter is substantially same as that of the infrared light emitted from the at least one infrared light source.

6. The optical touch device of claim 1, wherein the at least one infrared light source is an infrared light emitting diode.

7. The optical touch device of claim 1, wherein the display panel is a liquid crystal display or an organic light emitting diode display.

8. The optical touch device of claim 1, wherein the display panel is substantially rectangular, and the at least one infrared camera module is positioned at a top corner of the display panel.
